(19) United States
(12) Patent Application Publication
(10) Pub. No.: US 2018/0027468 A1
(43) Pub. Date: Jan. 25, 2018

(54) TECHNIQUES FOR LOAD BALANCING IN A NETWORK ENVIRONMENT

(71) Applicant: Zinwave Limited, Cambridge (GB)

(72) Inventors: Matthew P. Pasulka, Huntsville, AL (US); Andrew Robert Bell, Cambridge (GB)

(21) Appl. No.: 15/215,447

(22) Filed: Jul. 20, 2016

(51) Int. Cl. H04W 36/22; H04L 12/24; H04L 5/00; H04L 29/12

(52) U.S. Cl. CPC H04W 36/22; H04L 61/6022; H04L 41/50; H04L 5/003

(57) ABSTRACT

Embodiments of the present invention provide techniques for load balancing in a network environment. A wireless networking system can include a load balancer to determine how to distribute client devices across available channels to minimize interference and maximize bandwidth. A client device can access a wireless network through an access point. When a request is received from the client device to access the wireless network, the wireless networking system can determine device information associated with the device. For example, the request can include a device identifier. In some embodiments, account information, such as a user name and password, may be included with the request or received in response to a log-in prompt. In some embodiments connection information may also be determined. Based on the device information and the connection information, the client device can be assigned to a channel.

### BACKGROUND

Wireless networking is an increasingly common feature provided by businesses, residential and commercial spaces, municipalities, and other areas. Wireless networks allocate finite bandwidth to client devices as they connect. For example, wireless local area networks enable many common devices, such as desktop computers, laptop computers, smartphones, digital cameras, tablet computers and digital audio players, to communicate with one another, access network resources, connect to other networks, such as the internet, etc. A wireless network may be deployed using one or more access points arranged in a deployment environment (including indoor and outdoor locations).

These networks typically operate in the ISM (industrial, scientific, and medical) radio bands along with many other devices, such as microwaves, cordless telephones, Bluetooth devices, near field communication devices, etc. As such, these bands are increasingly crowded with devices, leading to increased interference. Additionally, these networks are increasingly installed in user-dense environments, such as dense commercial and residential buildings, event spaces, and the like. This leads to more client devices connecting to these networks, leading to various device management and network management issues.

Embodiments of the present invention provide techniques that address these and other problems in network environments.

### SUMMARY

Embodiments of the present invention provide techniques for load balancing in a network environment. Embodiments of the present invention provide techniques for load balancing in a network environment. A wireless networking system can include a load balancer to determine how to distribute client devices across available channels to minimize interference and maximize bandwidth. A client device can access a wireless network through an access point. When a request is received from the client device to access the wireless network, the wireless networking system can determine device information associated with the device. For example, the request can include a device identifier (e.g., a MAC address or other device identifier). In some embodiments, account information, such as a user name and password, may be included with the request or received in response to a log-in prompt. In some embodiments connection information may also be determined. Based on the device information and the connection information, the client device can be assigned to a channel.

### BRIEF DESCRIPTION OF THE DRAWINGS

Various embodiments in accordance with the present disclosure will be described with reference to the drawings, in which:

FIG. 1 illustrates an example of a network environment, in accordance with embodiments of the present invention;

FIG. 2 illustrates an example of multiple devices connecting to a single access point, in accordance with an embodiment of the present invention;

FIG. 3 illustrates a block diagram of an access point in a network environment, in accordance with an embodiment of the present invention;

FIG. 4 illustrates a method of load balancing in a network environment, in accordance with an embodiment of the present invention;

FIG. 5 illustrates a high level block diagram of a computer system, in accordance with an embodiment of the present invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present invention provide techniques for load balancing in a network environment. A wireless networking system can include a load balancer to determine how to distribute client devices across available channels to minimize interference and maximize bandwidth. A client device can access a wireless network through an access point. When a request is received from the client device to access the wireless network, the wireless networking system can determine device information associated with the device. For example, the request can include a device identifier (e.g., a MAC address or other device identifier). In some embodiments, account information, such as a user name and password, may be included with the request or received in response to a log-in prompt. In some embodiments connection information may also be determined. For example, a client device's maximum connection speed can be determined. Based on the device information and the connection information, the client device can be assigned to a channel. For example, the device information and connection information can be compared to one or more connection policies.

In some embodiments, the wireless networking system can manage connected devices among different channels. For example, connection policies may define how to manage devices connected to a channel when that channel is full based on, e.g., device information and connection information associated with the devices. In some embodiments, the connection policies may define how devices are managed based on the activity of those devices on the wireless network.

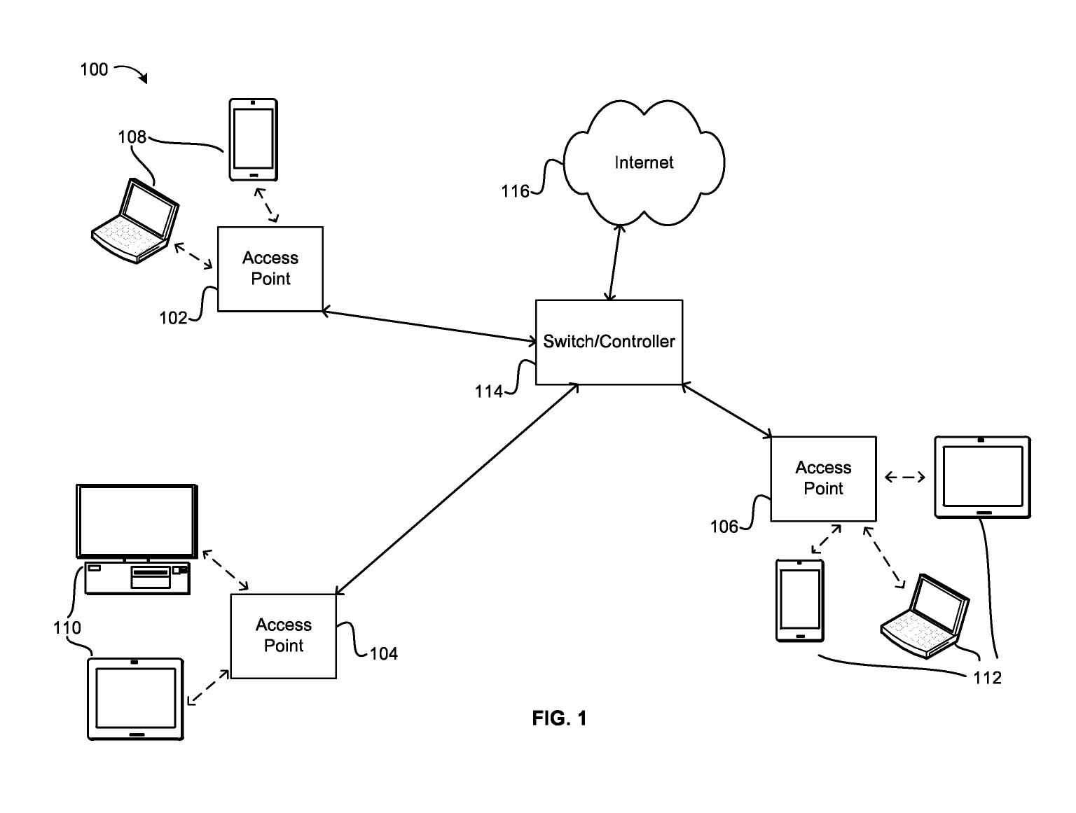

FIG. 1 illustrates an example of a network environment 100, in accordance with embodiments of the present invention. As shown in FIG. 1, a wireless networking system can include one or more wireless access points 102, 104, 106 which connect various client devices 108, 110, 112. In various embodiments, client devices may include personal computers, cell phones, handheld messaging devices, laptop computers, set-top boxes, personal data assistants, and any other suitable devices configured to send and receive information over a network. Although embodiments of the present invention are described herein with respect to a wireless local area network (WLAN) implemented using devices that support the IEEE 802.11 family of specifications, the wireless networking system can support any appropriate wireless network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail.

A given access point can communicate with multiple client devices within range of the access point in the deployment environment. The range of any given access point may vary depending on the placement of the access point within the deployment environment (e.g., indoor/outdoor placement, height, local physical obstructions, etc.), antenna type, power output, and local interference (e.g., from other devices operating in the same frequency range).

In the example shown in FIG. 1, switch/controller 114 connects the access points 102, 104, 106 to the internet 116. Switch/controller 114 may connect the access points to various network resources, such as a wired LAN, one or more local or remote servers, data stores, and other resources. In some embodiments, switch/controller 114 can manage more or fewer access points than are shown in FIG. 1. Additionally, multiple switches may be used to connect other access points to a LAN or other network resource. As discussed further below, device management can be performed by each access point 102, 104, 106, by switch/controller 114, or by a combination of devices. Such management functions can include power adjustments, device connection management, channel management, and security management (e.g., authentication, authorization, etc.).

For example, switch/controller 114 may provide authentication and authorization services for requests received to access the wireless network. In some embodiments, switch/controller 114 may connect to one or more servers to perform authentication and authorization, which may use information stored in one or more data stores to generate a login page to be displayed on the client device, through which account credentials (e.g., username and password) may be provided. In some embodiments, information may be served to the client devices using HyperText Markup Language (“HTML”), Extensible Markup Language (“XML”), or another appropriate structured language. In various embodiments, data stores may refer to a device or combination of devices configured to store, access, and retrieve data. Such devices may include data servers, databases, data storage devices, data storage media, or any combination thereof. In various embodiments, data stores may be deployed individually, or as a distributed or clustered system.

As discussed further below, as more client devices connect to an access point, the client devices can be assigned to different channels. As more devices connect, devices will share time on the same channel. Devices connected to the same channel each communicate with the access point in turn, with one device transmitting at a given time and other devices deferring communication. Different client devices implementing different versions of the 802.11 specification may connect to the same wireless network. However, as the specification has evolved, the timing parameters have changed. To be backwards compatible, a wireless network implementing an 802.11 standard uses the timing parameters associated with the slowest connected device for a given channel. This slows the connection speed of every client device connected to that channel. As such, improved connection management is needed to improve the performance of the wireless network and connected client devices.

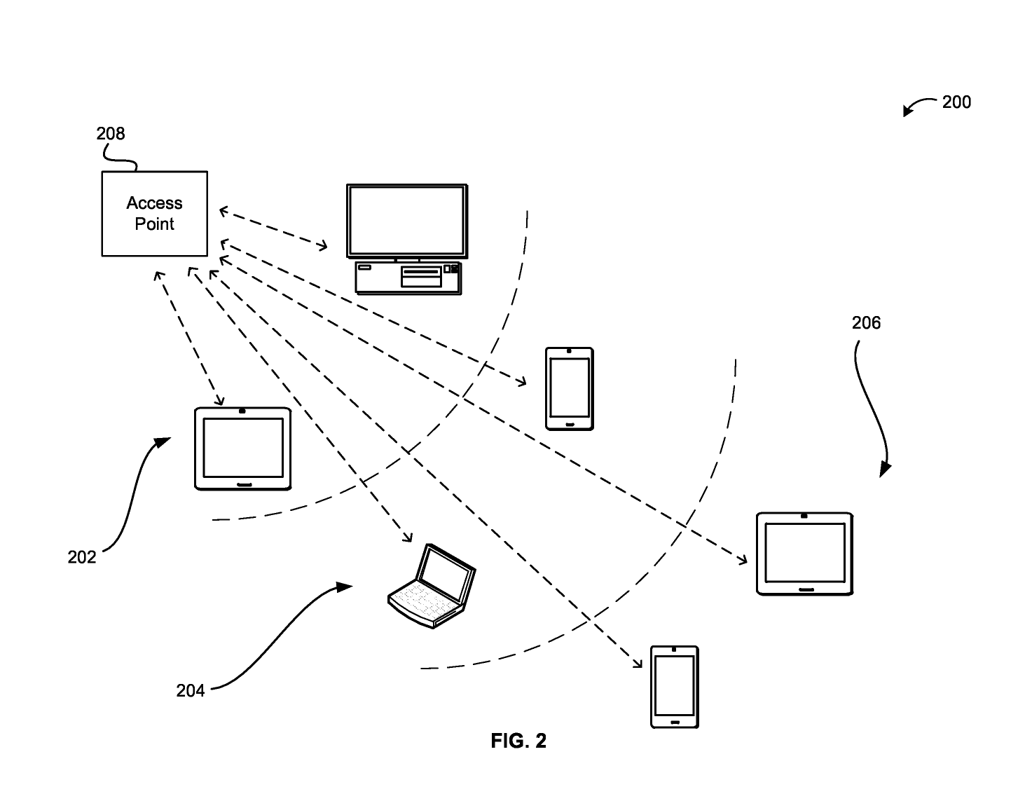

FIG. 2 illustrates an example 200 of multiple devices connecting to a single access point, in accordance with an embodiment of the present invention. Wireless networking systems, such as that described above with respect to FIG. 1, may include multiple access points deployed at different locations to increase network coverage and reduce interference. Deployment locations may be selected based on environmental conditions within the deployment area. For example, a wireless networking system that provides a wireless network in outdoor and indoor spaces may include access points that are deployed indoors, to protect the access points from weather conditions that may adversely affect the lifespan and functioning of the access points. Similarly, access points may be deployed to locations where physical access to the access points is limited, to avoid potential damage to the access points.

As shown in FIG. 2, various client devices 202, 204, 206 can connect to a wireless network through access point 208. As discussed above, each access point may service various client devices within the deployment area. As shown in FIG. 2, the client devices may access the access point 208 from various locations within the deployment area. As such, the connection with each device may be exposed to different levels of interference (e.g., from other nearby devices operating in the same frequency range, physical barriers, and the like) as well as different signal strengths (e.g., due to distance varying distances between the access point and the connected devices). For example, client devices 202 at the closest location to access point 208 may have the highest power signals, with lower interference, while client devices 204, 206 at locations farther from access point 208 may have lower power signals and/or more interference due to intervening devices and physical barriers, leading to higher error rates. As a result, the overall performance of the network may be negatively impacted by client devices 204, 206.

In some embodiments, the transmit power of access point 208 can be adjusted to achieve particular performance characteristics, such as range, data rate, or other performance characteristics. By increasing the transmit power, the signal to noise ratio (SNR) at more distance client devices 204, 206 to increase, improving communication with these client devices. Such power management improves the range of the access point 208, however if the transmit power of client devices 204, 206 are not also increased, the improvements to overall network performance may be minimal. Additionally, in many deployment environments the power levels of individual client devices may not be configurable by the wireless networking system.

In some embodiments, device management across available channels of the wireless network can be performed to improve network performance. Channels can be defined within the frequency bands used by the wireless networking system according to the type of wireless network being provided. For example, 802.11 wireless networks include 11 channels in the 2.4 GHz frequency band, which are spread across the frequency band. This results in three non-overlapping channels (e.g., channels 1, 6, and 11). Channel management can improve network performance by, e.g., avoiding interference that is specific to portions of the frequency band. More or fewer channels may be available depending on the operating frequency band and local regulations.

In some embodiments, access point 208 can manage client devices across available channels to improve network performance. For example, client devices implementing older and slower communication standards (e.g., 802.11b versus 802.11g, 802.11ac, etc.) may be assigned to one channel, while client devices implementing newer and fast communication standards may be assigned to a different channel. Because each device assigned to a particular channel communicates in turn, slower communicating client devices also slow communication of other devices connected to that channel. For example, a faster device may be delayed in communicating with the access point 208 while the access point is communicating with a slower device. Additionally, some channels overlap within the operating frequency band. Slower devices connected to one channel may also reduce the performance of devices connected to overlapping channels. As such, various connection and channel policies may be used to load balance devices across the available channels of the wireless networking system to improve the performance of the wireless network.

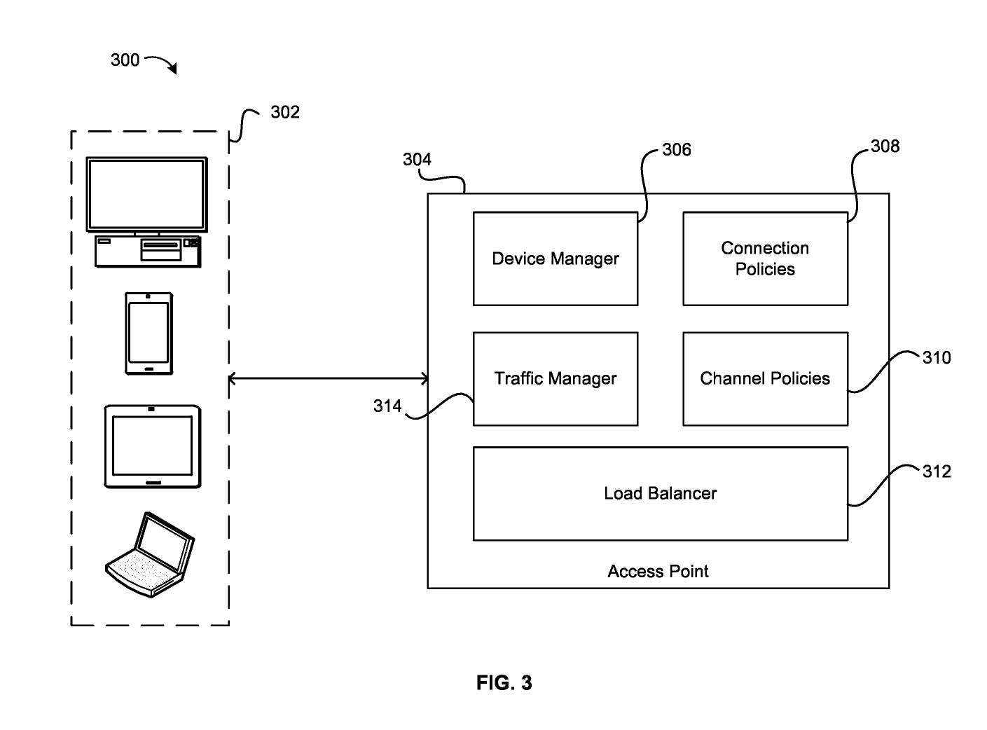

FIG. 3 illustrates a block diagram of an access point in a network environment 300, in accordance with an embodiment of the present invention. As discussed above, one or more clients 302 can access a wireless network through an access point 304. Although the embodiment shown in FIG. 3 includes an access point 304 configured to manage the client devices 302 connected thereto, in some embodiments, all or portions of this management functionality may be embodied in a controller, such as switch/controller 114, a wireless LAN controller, or other suitable controller, configured to manage multiple access points.

As shown in FIG. 3, access point 304 can include a device manager 306. When a client device requests to connect to access point 304, device manager 306 can determine client device information and connection information. For example, device manager 306 can receive a device identifier associated with the request. In some embodiments, device manager 306 can control access to the wireless network, for example by comparing the device identifier with a whitelist and/or blacklist of device identifiers. Additionally, or alternatively, device manager 306 can receive credential information, such as a username and password, from the client device and provide authentication and/or authorization services. In some embodiments, device manager 306 can send the credential information to an authentication and/or authorization server and receive an authentication and/or authorization decision. Device manager 306 can maintain a history of connected device identifiers and authentication and/or authorization decisions.

In some embodiments, access point 304 can include one or more connection policies 308. Connection policies may define one or more performance thresholds for devices to connect to particular channels. For example, connection policies 308 can define performance thresholds for a fast channel, a medium channel, and a slow channel, where each threshold is associated with a range of connection speeds. In some embodiments, the thresholds may be dynamically determined based on e.g., the current connection speeds of client devices connected to the access point, interference, or other network and/or environmental conditions. For example, an average of connection speeds of client devices connected to a channel may be set as the threshold for that channel. In some embodiments, thresholds may be defined based on quality of service (QoS) parameters. For example, thresholds may be set to ensure at least one channel that provides a minimum transfer speed based on the QoS parameters.

As shown in FIG. 3, access point 304 may include one or more channel policies. The channel policies may define conditions under which multiple channels are bonded to provide increased throughput. For example, if many devices are assigned to a first channel (e.g., based on the connection policies described above), and a second channel is unused, the first and second channels may be combined to increase available bandwidth to the client devices. In some embodiments, channel policies may include conditions that ensure quality of service based on QoS parameters.

In some embodiments, load balancer 312 can assign a client device to channels when the client device connects to the access point and/or may reassign connected client devices to channels based on connection policies 308 and channel policies 310. In some embodiments, when a client connects to the wireless network, device manager 306 can determine whether the client device has previously connected to the wireless network and/or whether the client device was previously assigned to a particular channel. In some embodiments, if the client device has been connected to the wireless network within a threshold time, the client device can be reconnected to the same channel. In some embodiments, if the client device has not previously connected to the wireless network, or if the client device has not connected within the threshold time, load balancer 312 can determine a channel to assign the client device using connection policies 308 and channel policies 310.

For example, in some embodiments, the connection speed associated with a client device may be compared to thresholds defined in connection policies 308, and the client device may be assigned to a channel corresponding to the matching threshold. In some embodiments, channels may be prioritized to particular users or types of users. For example, emergency service personnel, employees, premium account holders, or other types of users may be prioritized. These users may be assigned based on credential information received from the client device at log-in and/or based on a device identifier associated with the client device. In some embodiments, when a client device connects to the wireless network, the channel to which that client device is determined to be assigned may be full.

In determining a channel to which to assign a client device, load balancer 312 may apply one or more load balancing rules. For example, if load balancer 312 determines that a previously connected client device needs to be dropped from a channel to connect a new client device to that channel, the load balancer can apply a “last in first out” (LIFO) rule to select the most recently connected device to drop. Alternatively, a “first in first out” (FIFO) rule can be applied to select the client device that has been connected for the longest period of time. In some embodiments, device information may be used to determine which device to drop from the channel. For example, if the new device requesting to connect has a high maximum transmission speed, then the device with the lowest maximum transmission speed on the channel may be selected to be dropped from the channel. This rule benefits other devices connected to that channel by generally increasing the overall performance of the channel.

In some embodiments, the load balancer 312 can combine channels based on channel policies 310 by determining that another available channel has few connected client devices and/or limited traffic activity. In such a case, the channels may be bonded and the new client added to the new channel. In some embodiments, load balancing rules may be ordered hierarchically, enabling multiple load balancing rules to be applied in a particular order. For example, load balancer 312 may determine that particular client devices are not to be dropped based on their device identifiers, the slowest connected device of the remaining devices on the channel may then be selected to be dropped.

In some embodiments, one or more device queues may be maintained associated with each channel. Devices in the one or more device queues may be given priority to connect to the associated channel when access to the channel becomes available. When a new device attempts to connect to a channel that is full, the new device can instead be connected to an open, though potentially slower channel. The new device can also be added to a queue associated with the faster channel. As client devices disconnect from the faster channel, devices may be connected to the faster channel from the queue. Similarly, if a client device is selected to be dropped from the faster channel to make room for the new client device, that client device may be added to the queue associated with the faster channel. This way a client device that is dropped may be given priority to rejoin the faster channel when access becomes available.

In some embodiments, load balancer 312 may select a client device to drop from a channel based on the activity of that client device. For example, traffic manager 314 can inspect the traffic associated with the client device and give priority to devices based on that traffic. Packet analysis techniques may be used to analyze, e.g., raw packet data, header data, or other packet information to determine what activities the user is performing while connected to the network. Load balancer 312 may then give priority to devices engaged in some types of traffic over others. For example, in a wireless network deployed to an event space, such as a stadium or conference center, a client device viewing or sending data about the event may receive priority over a client device requesting unrelated video data.

As discussed above, in some embodiments client devices may be dropped from one channel and added to a different channel. To minimize service disruption for the reassigned client device, the client may be handed-off between channels based on the type of activity the user is engaged in. For example, a user who is browsing websites may be disconnected from their current channel when a page has finished loading and connected to a new channel. This way, the period during which the user is not connected is limited to the time during which the user is consuming content that has already loaded. Similarly, a user making a voice call may not be disconnected until the call has completed, to avoid potential service disruptions. In some embodiments, where nearby access points are available, the client device may be connected to the appropriate channel at a new access point before being disconnected from the current channel at the current access point. As discussed above, the user may be added to a queue associated with the channel and access point from which they were disconnected, enabling the user to be reconnected when the channel again becomes available.

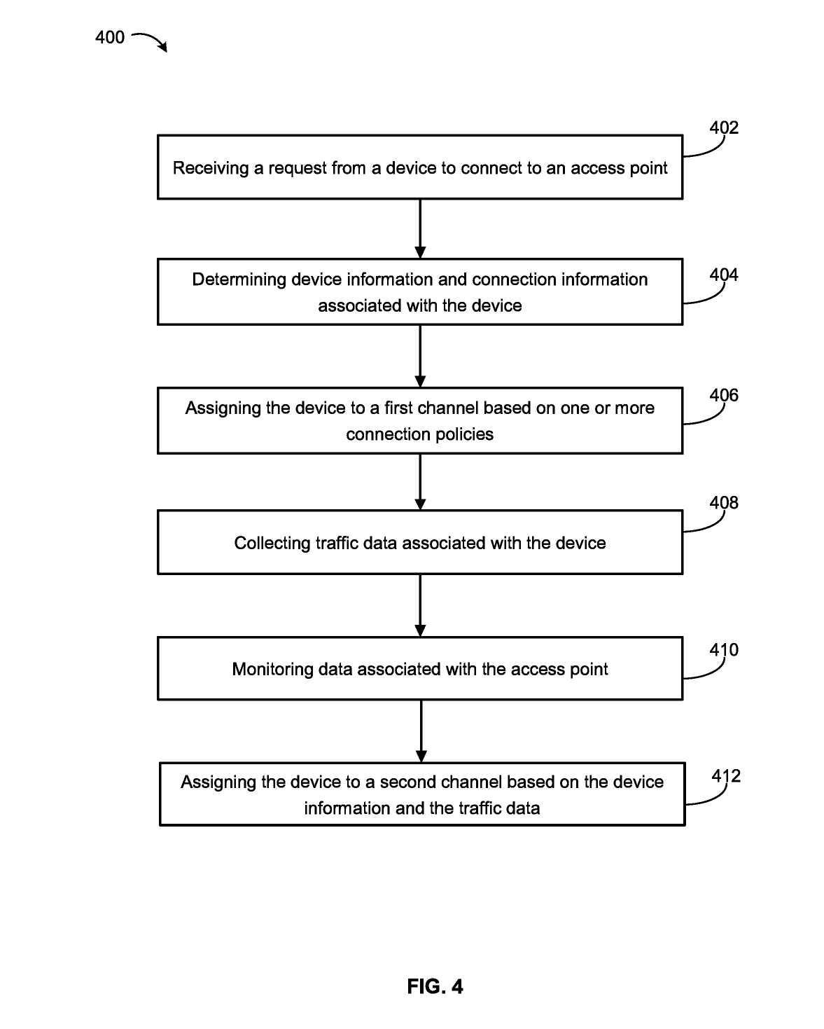

FIG. 4 illustrates a method 400 of load balancing in a network environment, in accordance with an embodiment of the present invention. As discussed above, as client devices connect to a wireless network, the client devices can be load balanced to improve network performance. Although in the described embodiments, client device management is performed by the access point, such device management may be performed by a controller that manages multiple access points.

At 402, a request is received from a client device to connect to an access point. As discussed above, client devices can connect to a wireless network through an access point. The access point may manage multiple client devices. In some embodiments, an access point may include one or more transceivers configured to communicate over one or more frequency bands which may be divided into a plurality of channels depending on the type of wireless network being provided.

At 404, device information and connection information associated with the client device is determined. As discussed above, device information may include a device identifier and/or credential information associated with a user of the client device. In some embodiments, device information may be stored by the access point and maintained in a connection history to track past device connections. Connection information may include performance data such as maximum connection speed.

At 406, the client device is assigned to a first channel based on the device information, connection information, and one or more connection policies. In some embodiments, connection policies can define thresholds associated with a plurality of channels. For example, each channel may be associated with a range of connection speeds. As discussed above, the performance of a channel may be limited by the slowest performing client device connected to that channel. As such, the connection policies enable the access points to improve the performance of the wireless networks by grouping similarly performing client devices into the same channel.

At 408, traffic data associated with the client device is collected. For example, a traffic analyzer, packet analyzer, or other data analyzer may be used to collect traffic associated with a client device. The traffic can be analyzed to determine a type of traffic, such as video streaming, web browsing, voice calling, or other activity. In some embodiments, one or more load balancing rules can be used to select the client device to be reassigned to a second channel based on the type of activity. For example, activity related to a provider of the wireless network may be given priority over unrelated activity. In some embodiments, a client device may be reassigned based on the type of activity, for example a client device may be reassigned after requested data (such as a web page has loaded).

At 410, data associated with the access point is monitored. For example, a plurality of requests can be received from a plurality of client devices to connect to the access point. As more client devices connect to the wireless network through the access point, the performance of the network can be slowed, as discussed above. As such, the plurality of client devices can be load balanced across the plurality of channels based on one or more load balancing rules. The client device being reassigned can be selected by applying the one or more load balancing rules to the plurality of client devices.

At 412, the client device is reassigned to a second channel based on the device information and the traffic data. In some embodiments, the client device can be added to a queue associated with the first channel. The queue can include one or more client devices that receive priority to reconnect to the first channel.

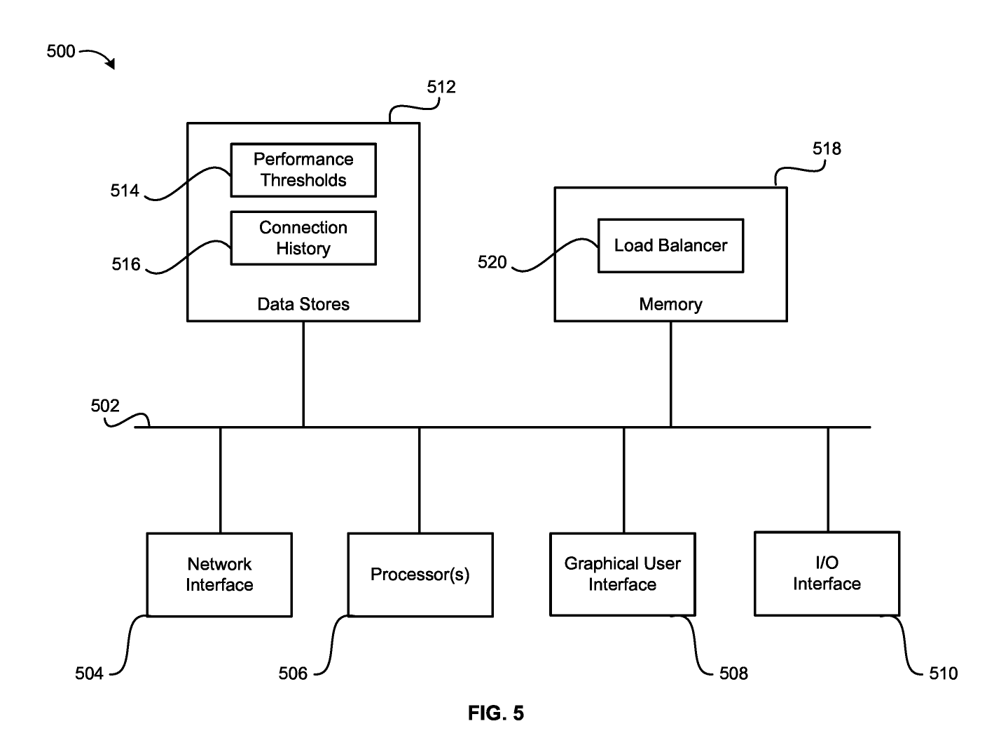

FIG. 5 illustrates a high level block diagram of a computer system 500, in accordance with an embodiment of the present invention. As shown in FIG. 5, a computer system can include hardware elements connected via a bus 502, including a network interface 504, that enables the computer system to connect to other computer systems over a wireless local area network (WLAN), wide area network (WAN), mobile network (e.g., EDGE, 3G, 4G, or other mobile network), or other network. Network interface 504 can further include a wired or wireless interface for connecting to infrared, Bluetooth, or other wireless devices, such as other client devices, network resources, or other wireless capable devices. The computer system can further include one or more processors 506, such as a central processing unit (CPU), field programmable gate array (FPGA), application-specific integrated circuit (ASIC), network processor, or other processor. Processers may include single or multi-core processors.

In some embodiments, the computer system can include a graphical user interface (GUI) 508. GUI 508 can connect to a display (LED, LCD, tablet, touch screen, or other display) to output user viewable data. In some embodiments, GUI 508 can be configured to receive instructions (e.g., through a touch screen or other interactive interface). In some embodiments, I/O interface 510 can include various interfaces for user input devices including keyboards, mice, or other user input devices.

In some embodiments, the computer system may include local or remote data stores 512. Data stores 512 can include various computer readable storage media, storage systems, and storage services, as are known in the art (e.g., disk drives, CD-ROM, digital versatile disk (DVD) or other optical storage, magnetic cassettes, magnetic tape, magnetic disk storage or other magnetic storage devices, relational databases, object storage systems, local or cloud-based storage services, or any other storage medium, system, or service). Data stores 510 can include data generated, stored, or otherwise utilized as described herein. For example, data stores 510 can include all or portions of performance thresholds 514 and other connection policies, as well as connection history 516 and other client device data, generated and stored as described above. Memory 518 can include various memory technologies, including RAM, ROM, EEPROM, flash memory or other memory technology. Memory 518 can include executable code to implement methods as described herein, such as load balancer 520.

A computing device typically will include an operating system that provides executable program instructions for the general administration and operation of that computing device and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving a request from a client device to connect to an access point;
determining device information and connection information associated with the client device;
assigning the client device to a first channel based on the device information, connection information, and one or more connection policies;
collecting traffic data associated with the client device;
receiving a plurality of requests from a plurality of client devices to connect to the access point;
load balancing the plurality of client devices to the plurality of channels based on one or more load balancing rules; and
reassigning the client device to a second channel based on the device information and the traffic data.

2. The method of claim 1, wherein the device information includes at least one of a device identifier or credential information associated with a user of the client device.

3. The method of claim 1, wherein the one or more connection policies define one or more performance thresholds associated with a plurality of channels.

4. The method of claim 1, wherein the client device is selected by applying the one or more load balancing rules to the plurality of client devices.

5. The method of claim 1, wherein collecting traffic data associated with the client device further comprises:
determining a type of activity associated with the traffic data; and
wherein the one or more load balancing rules select the client device to be reassigned to the second channel based on the type of activity.

6. The method of claim 5, wherein the client device is reassigned to the second channel at a time determined based on the type of activity.

7. The method of claim 1, further comprising:
adding the client device to a queue associated with the first channel, wherein the queue includes one or more client devices that receive priority to reconnect to the first channel.

8. A wireless networking system comprising:
at least one access point, include a computer readable medium and processor, the at least one access point configured to:
receive a request from a client device to connect to an access point;
determine device information and connection information associated with the client device;
assign the client device to a first channel based on the device information, connection information, and one or more connection policies;
collect traffic data associated with the client device;
receive a plurality of requests from a plurality of client devices to connect to the access point;
load balance the plurality of client devices to the plurality of channels based on one or more load balancing rules; and
reassign the client device to a second channel based on the device information and the traffic data.

9. The wireless networking system of claim 8, wherein the device information includes at least one of a device identifier or credential information associated with a user of the client device.

10. The wireless networking system of claim 8, wherein the one or more connection policies define one or more performance thresholds associated with a plurality of channels.

11. The wireless networking system of claim 8, wherein the client device is selected by applying the one or more load balancing rules to the plurality of client devices.

12. The wireless networking system of claim 8, wherein collecting traffic data associated with the client device further comprises:
determining a type of activity associated with the traffic data; and
wherein the one or more load balancing rules select the client device to be reassigned to the second channel based on the type of activity.

13. The wireless networking system of claim 12, wherein the client device is reassigned to the second channel at a time determined based on the type of activity.

14. The wireless networking system of claim 8, wherein the at least one access point is further configured to:
add the client device to a queue associated with the first channel, wherein the queue includes one or more client devices that receive priority to reconnect to the first channel.

15. A non-transitory computer readable storage medium including instructions stored thereon which, when executed by a processor, cause the processor to:
receive a request from a client device to connect to an access point;
determine device information and connection information associated with the client device;
assign the client device to a first channel based on the device information, connection information, and one or more connection policies;
collect traffic data associated with the client device;
receive a plurality of requests from a plurality of client devices to connect to the access point;
load balance the plurality of client devices to the plurality of channels based on one or more load balancing rules; and
reassign the client device to a second channel based on the device information and the traffic data.

16. The non-transitory computer readable storage medium of claim 15, wherein the device information includes at least one of a device identifier or credential information associated with a user of the client device.

17. The non-transitory computer readable storage medium of claim 15, wherein the one or more connection policies define one or more performance thresholds associated with a plurality of channels.

18. The non-transitory computer readable storage medium of claim 15, wherein the client device is selected by applying the one or more load balancing rules to the plurality of client devices.

19. The non-transitory computer readable storage medium of claim 15, wherein collecting traffic data associated with the client device further comprises:
determining a type of activity associated with the traffic data; and
wherein the one or more load balancing rules select the client device to be reassigned to the second channel based on the type of activity.

20. The non-transitory computer readable storage medium of claim 19, wherein the client device is reassigned to the second channel at a time determined based on the type of activity.
